(19) United States
(12) Patent Application Publication
(10) Pub. No.: US 2025/0175042 A1
(43) Pub. Date: May 29, 2025

(54) ROTOR AND ROTARY ELECTRIC MACHINE

(71) Applicant: NIDEC CORPORATION, Kyoto (JP)

(72) Inventors: Yu-Wei HSU, Taipei City (TW); Hsin-Nan LIN, Taipei City (TW); Guo-Jhih YAN, Taipei City (TW); Cheng-Tsung LIU, Kaohsiung (TW)

(21) Appl. No.: 18/842,030

(22) PCT Filed: Feb. 22, 2023
(86) PCT No.: PCT/JP2023/006399

§ 371 Date: Aug. 27, 2024

(30) Foreign Application Priority Data
Feb. 28, 2022 (JP) 2022-029760

(51) Int. Cl. H02K 1/24; H02K 19/10

(52) U.S. Cl. CPC H02K 1/246; H02K 19/103

(57) ABSTRACT

A rotor is a rotor rotatable about a central axis, and includes a rotor core and a plurality of flux barrier groups provided in the rotor core and arranged at intervals in a circumferential direction. Each of a plurality of the flux barrier groups includes a plurality of flux barriers arranged side by side at intervals in a radial direction, the rotor core has a projecting portion projecting from an edge portion of the flux barrier toward the inside of the flux barrier, and in each of a plurality of the flux barrier groups, an edge portion of at least one of the flux barriers is provided with two or more of the projecting portions.

### CROSS-REFERENCE TO RELATED APPLICATIONS

This is the U.S. national stage of application No. PCT/JP2023/006399, filed on Feb. 22, 2023, and priority under 35 U.S.C. § 119(a) and 35 U.S.C. § 365(b) is claimed from Japanese Patent Application No. 2022-029760, filed on Feb. 28, 2022.

### TECHNICAL FIELD

The present invention relates to a rotor and a rotary electric machine.

### BACKGROUND ART

A rotor of a rotary electric machine including a rotor core and a hole provided in the rotor core is known. For example, a rotor of Patent Literature 1 has a plurality of holes serving as a flux barrier having a projecting shape toward the outer side in a radial direction when viewed in an axial direction of the rotor, and a plurality of holes arranged at intervals on an outer side in a circumferential direction. A conductor is arranged on the inner side of the hole arranged on the outer side in the circumferential direction.

### CITATIONS LIST

### Patent Literature

Patent Literature 1: US 7,282,829.

### SUMMARY OF INVENTION

### Technical Problems

In the rotor of Patent Literature 1, when rotation of the rotor is started, if a direction of flow of a magnetic flux generated by a stator is not the same as an extending direction of a magnetic path between flux barriers, there has been a case where a magnetic field generated by the stator cannot be suitably used as a magnetic field that generates torque of the rotor. In this case, there has been a case where an inertial load of the rotor at the time of starting a rotary electric machine exceeds a maximum inertial load of a rotary electric machine allowable in a case where the rotor is rotated to a rated speed, and a rotational speed of the rotor cannot be increased to the rated speed.

In view of the above circumstances, one object of the present disclosure is to provide a rotor and a rotary electric machine having a structure in which an allowable inertial load can be increased at the time of starting the rotary electric machine.

### Solutions to Problems

One aspect of a rotor of the present disclosure is a rotor rotatable about a central axis, and includes a rotor core and a plurality of flux barrier groups provided in the rotor core and arranged at intervals in a circumferential direction. Each of a plurality of the flux barrier groups includes a plurality of flux barriers arranged side by side at intervals in a radial direction. The rotor core has a projecting portion projecting from an edge portion of the flux barrier to the inside of the flux barrier, and in each of a plurality of the flux barrier groups, an edge portion of at least one of the flux barriers is provided with two or more of the projecting portions.

One aspect of a rotary electric machine of the present disclosure includes the rotor and a stator located outside in the radial direction of the rotor.

### Advantageous Effects of Invention

According to one aspect of the present disclosure, it is possible to provide a rotor and a rotary electric machine having a structure capable of improving an allowable inertial load at the time of startup of the rotary electric machine.

### BRIEF DESCRIPTION OF DRAWINGS

FIG. 1 is a cross-sectional view illustrating a rotary electric machine according to the present embodiment.

FIG. 2 is a cross-sectional view illustrating a rotor and a stator according to the present embodiment, and is a cross-sectional view taken along line II-II in FIG. 1.

FIG. 3 is a diagram for explaining flow of a magnetic flux in the rotor of the present embodiment.

FIG. 4 is a cross-sectional view illustrating a variation of the rotor of the present embodiment.

FIG. 5 is a cross-sectional view illustrating another variation of the rotor of the present embodiment.

FIG. 6 is a diagram for explaining flow of a magnetic flux in the rotor illustrated in FIG. 5.

FIG. 7 is a diagram for explaining flow of a magnetic flux in the rotor when a magnetic field illustrated in FIG. 6 rotates.

FIG. 8 is a diagram for explaining flow of a magnetic flux in the rotor when a magnetic field illustrated in FIG. 7 further rotates.

FIG. 9 is a cross-sectional view illustrating another variation of the rotor of the present embodiment.

FIG. 10 is a cross-sectional view illustrating another variation of the rotor of the present embodiment.

FIG. 11 is a partially enlarged diagram of the rotor illustrating another variation of the rotor of the present embodiment.

FIG. 12 is a partially enlarged diagram of the rotor illustrating another variation of the rotor of the present embodiment.

FIG. 13 is a partially enlarged diagram of the rotor illustrating another variation of the rotor of the present embodiment.

### DESCRIPTION OF EMBODIMENT

A Z-axis direction appropriately illustrated in each drawing is a vertical direction in which the positive side is the “upper side” and the negative side is the “lower side”. A central axis J appropriately illustrated in each drawing is an imaginary line that is parallel to the Z-axis direction and extends in the vertical direction. In description below, an axial direction of the central axis J, that is, a direction parallel to the vertical direction is simply referred to as “axial direction”, a radial direction about the central axis J is simply referred to as “radial direction”, and a circumferential direction about the central axis J is simply referred to as “circumferential direction”. When viewed from the upper side in the axial direction, a clockwise direction in the circumferential direction is referred to as the +θ side, and a counterclockwise direction is referred to as the −θ side.

Note that the vertical direction, the upper side, and the lower side are names for simply describing an arrangement relationship of each portion and the like, and an actual arrangement relationship and the like may be also an arrangement relationship and the like other than the arrangement relationship and the like indicated by these names.

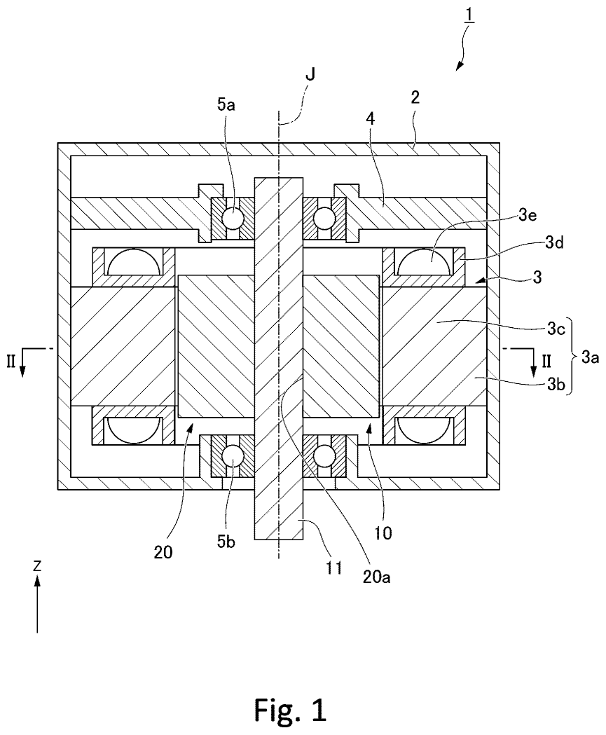

As illustrated in FIG. 1, a rotary electric machine 1 of the present embodiment is an inner rotor type motor. As illustrated in FIG. 1, the rotary electric machine 1 of the present embodiment includes a housing 2, a rotor 10, a stator 3, a bearing holder 4, and bearings 5a and 5b. The housing 2 accommodates the rotor 10, the stator 3, the bearing holder 4, and the bearings 5a and 5b in the inside. A bottom portion of the housing 2 holds the bearing 5b. The bearing holder 4 holds the bearing 5a. For example, the bearings 5a and 5b are a ball bearing.

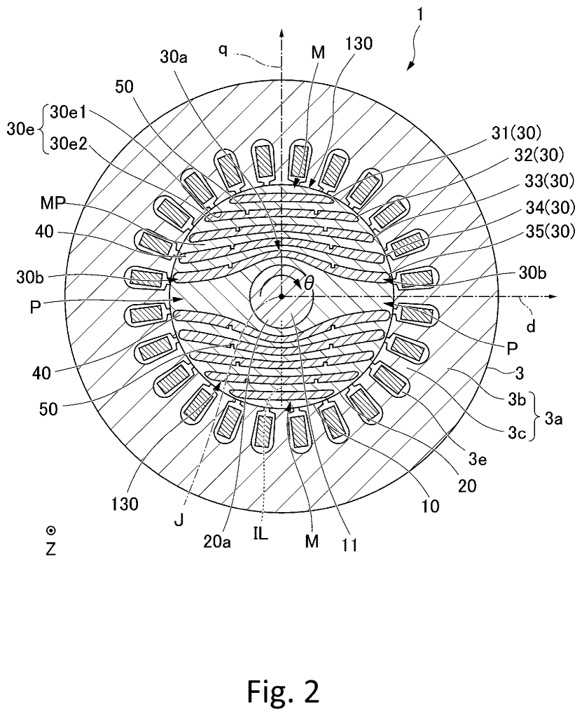

The stator 3 is located outside in the radial direction of the rotor 10. As illustrated in FIG. 1, the stator 3 includes a stator core 3a, an insulator 3d, and a plurality of coils 3e. As illustrated in FIG. 2, the stator core 3a includes a core back 3b and a plurality of teeth 3c. The core back 3b has an annular shape around the central axis J. A plurality of the teeth 3c extend inward in the radial direction from the core back 3b. A plurality of the teeth 3c are arranged at equal intervals over one circumference along the circumferential direction. A plurality of the coils 3e are attached to the stator core 3a with the insulator 3d interposed between them.

The rotor 10 is rotatable about the central axis J. As illustrated in FIG. 2, the rotor 10 includes a shaft 11 and a rotor core 20. The shaft 11 has a columnar shape extending in the axial direction around the central axis J. As illustrated in FIG. 1, the shaft 11 is rotatably supported around the central axis J by the bearings 5a and 5b.

The rotor core 20 is a magnetic body. A material of the rotor core 20 is, for example, silicon steel having higher magnetic permeability and lower electrical conductivity than an alloy of iron and carbon. The rotor core 20 is fixed to an outer peripheral surface of the shaft 11. The rotor core 20 has a through hole 20a that penetrates the rotor core 20 in the axial direction. As illustrated in FIG. 2, the through hole 20a has a circular shape around the central axis J as viewed in the axial direction. The shaft 11 passes through the through hole 20a. The shaft 11 is fixed inside the through hole 20a by press fitting, for example. Although not illustrated, the rotor core 20 is constituted by, for example, a plurality of electromagnetic steel plates laminated in the axial direction.

The rotor core 20 has a plurality of flux barriers 30. In the present embodiment, each of the flux barriers 30 is constituted by a hole provided in the rotor core 20. The flux barrier 30 penetrates the rotor core 20 in the axial direction, for example. Each of the flux barriers 30 extends along a plane orthogonal to the axial direction, and has a shape projecting to the outer side in the radial direction when viewed in the axial direction. The rotor core 20 is provided with a plurality of sets including two or more of the flux barriers 30. One set of the flux barriers 30 is also referred to as a flux barrier group 130. Each of the flux barrier groups 130 includes a plurality of the flux barriers 30.

The rotor 10 provided with the flux barrier 30 as described above is a rotor of a synchronous reluctance motor having a magnetic salient pole structure. More specifically, when viewed from the axial direction, a salient pole direction in which a magnetic flux easily passes is provided between two adjacent sets of the flux barrier groups 130, and a direction in which a magnetic flux hardly passes is provided at a central portion in the circumferential direction of one set of the flux barrier groups 130. Note that, in description below, the above salient pole direction in which a magnetic flux easily passes is referred to as a “d-axis direction”, and the above direction in which a magnetic flux hardly passes is referred to as a “q-axis direction”. Since the rotor 10 has magnetic anisotropy in the q-axis direction and the d-axis direction, reluctance torque is generated when a magnetic field is generated by the stator 3, and the rotor 10 can be rotated.

Further, the d-axis direction is a radial direction passing through the center in the circumferential direction of a magnetic pole portion P of the rotor 10, and the q-axis direction is a radial direction passing through the center in the circumferential direction between the magnetic pole portions P adjacent to each other in the circumferential direction. A portion located between the magnetic pole portions P adjacent to each other in the circumferential direction is hereinafter referred to as a magnetic pole intermediate portion M. A q axis passes through the magnetic pole intermediate portion M.

As described above, the rotor 10 is provided with a plurality of the magnetic pole portions P provided along the circumferential direction and a plurality of the magnetic pole intermediate portions M located between the magnetic pole portions P adjacent to each other in the circumferential direction. Each of the magnetic pole intermediate portions M includes the flux barrier group 130.

In the present embodiment, a conductor 40 is arranged in the flux barrier 30. Among a plurality of the flux barriers 30, the inside of all the flux barriers 30 is filled with the conductor 40. A material constituting the conductor 40 is a material having high electrical conductivity. Examples of the material constituting the conductor 40 include aluminum, copper, and an alloy of aluminum and copper. The material constituting the conductor 40 is metal that is not a ferromagnetic material so as not to affect a magnetic salient pole structure constituted by the flux barrier 30.

The conductor 40 in the flux barrier 30 is formed by heating metal to be the conductor 40 and causing the metal to flow into the flux barrier 30.

In a case where the conductor 40 is arranged in the flux barrier 30 of a synchronous reluctance motor, a conductor is arranged in a rotating magnetic field. For this reason, when a magnetic field generated by the stator 3 rotates, induced current flows through the conductor 40 by electromagnetic induction, and a rotational force can be generated in the rotor 10 by the Lorentz force of the induced current. In particular, since torque by the Lorentz force can be obtained when rotation of the rotor 10 in a stationary state is started, an allowable inertial load at the time of starting the rotary electric machine 1 can be improved. As described above, a synchronous reluctance motor with an improved characteristic at the time of startup is also particularly referred to as Direct-On-Line Synchronous Reluctance Motor (DOL SynRM).

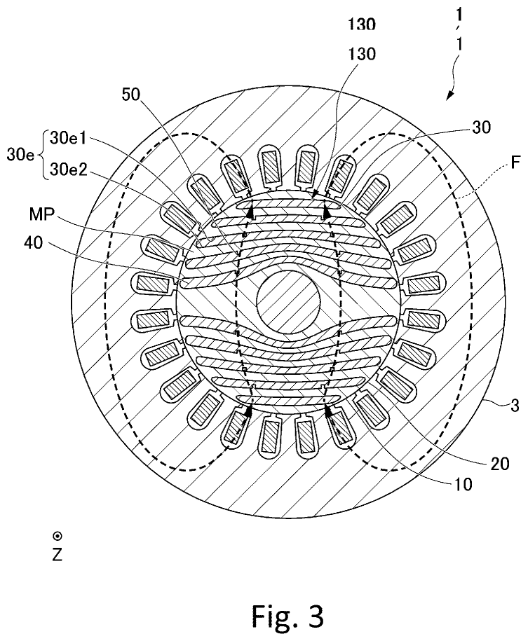

Here, in the rotor 10 having a magnetic salient pole structure, since the conductor 40 is not arranged in the magnetic pole portion P, an amount of the conductor 40 arranged in the circumferential direction is not uniform. Further, as illustrated in FIG. 3, in a case where a direction in which a magnetic flux F generated by the stator 3 flows at the time of startup does not coincide with an extending direction of a magnetic path MP in which a magnetic flux flows in the rotor core 20, there has been a case where the magnetic flux F cannot suitably pass through the rotor 10, and the Lorentz force generated at the time of startup cannot be sufficiently obtained. Note that the magnetic path MP is a region between a plurality of the flux barriers 30 and a region in the vicinity of the flux barrier 30 in the rotor core 20.

In view of the above, the inventors have found that by arranging a projecting portion 50 of the rotor core 20 projecting from an edge portion 30e of the flux barrier 30 to the inside of the flux barrier 30, the magnetic flux F can be suitably caused to pass through the rotor 10 regardless of a flowing direction of the magnetic flux F generated by the stator 3 at the time of startup. By arranging the projecting portion 50, the magnetic flux F generated by the stator 3 can be suitably caused to flow along the projecting portion 50 even in a state where an extending direction of the magnetic path MP does not coincide with a flow direction of the magnetic flux F generated by the stator 3 as illustrated in FIG. 3. By the above, since torque due to the Lorentz force can be obtained when rotation of the rotor 10 in a stationary state is started, an allowable inertial load at the time of starting the rotor 10 can be improved.

Hereinafter, a configuration of the flux barrier 30 and the projecting portion 50 of the rotor 10 will be described in more detail with reference to FIGS. 2 and 3.

### Flux Barrier 30

As illustrated in FIG. 2, the rotor 10 of the present embodiment includes two sets of the flux barrier groups 130 each including a first barrier portion 31, a second barrier portion 32, a third barrier portion 33, a fourth barrier portion 34, and a fifth barrier portion 35.

In the present embodiment, five of the flux barriers 30 are arranged in one set of the flux barrier groups 130. The number of the flux barriers 30 in one set of the flux barrier groups 130 is not limited to five, and is not particularly limited as long as the number is two or more. The number of the flux barriers 30 may be appropriately changed according to size of the rotor 10.

Hereinafter, in a case where any of the first barrier portion 31 to the fifth barrier portion 35 is referred to, the barrier portion is also simply referred to as the flux barrier 30.

Two sets of the flux barrier groups 130 are arranged at equal intervals along the circumferential direction of the rotor 10. Further, two sets of the flux barrier groups 130 face each other with the through hole 20a interposed between them. Each set of the flux barrier groups 130 have the same configuration except that each set is arranged in a posture rotated by 180° in the circumferential direction. In description of each of the flux barriers 30 below, the flux barrier 30 included in one set as a representative of two sets of the flux barrier groups 130 will be described.

Among a plurality of the flux barriers 30 included in the flux barrier group 130, the first barrier portion 31, the second barrier portion 32, the third barrier portion 33, the fourth barrier portion 34, and the fifth barrier portion 35 are arranged in this order from the outer side in the radial direction toward the inner side in the radial direction. The flux barriers 30 are not in contact with each other and are located apart from each other in the radial direction. In the rotor core 20, a region on the outer side in the radial direction of the first barrier portion 31, a region between two of the flux barriers 30 adjacent to each other in the radial direction, and a region on the inner side in the radial direction of the fifth barrier portion 35 form the magnetic path MP through which a magnetic flux flows.

The first barrier portion 31 to the fifth barrier portion 35 extend in a direction intersecting the q axis as viewed in the axial direction. In the present embodiment, each of the first barrier portion 31 to the fifth barrier portion 35 has a line-symmetric shape with the q axis as a symmetry axis when viewed in the axial direction.

In description below, a direction in which the flux barrier 30 extends as viewed in the axial direction is referred to as an “extending direction”. Directions in which the first barrier portion 31, the second barrier portion 32, the third barrier portion 33, the fourth barrier portion 34, and the fifth barrier portion 35 extend as viewed in the axial direction are referred to as a “first extending direction”, a “second extending direction”, a “third extending direction”, a “fourth extending direction”, and a “fifth extending direction”, respectively.

As viewed in the axial direction, the flux barrier 30 located on the outer side in the radial direction has a shorter dimension in the extending direction of the flux barrier 30. That is, a dimension in the first extending direction of the first barrier portion 31 is shorter than a dimension in the second extending direction of the second barrier portion 32. A dimension in the second extending direction of the second barrier portion 32 is shorter than a dimension in the third extending direction of the third barrier portion 33. A dimension in the third extending direction of the third barrier portion 33 is shorter than a dimension in the fourth extending direction of the fourth barrier portion 34. A dimension in the fourth extending direction of the fourth barrier portion 34 is shorter than a dimension in the fifth extending direction of the fifth barrier portion 35.

When viewed in the axial direction, each of the flux barriers 30 is curved in a projecting shape toward the outer side in the radial direction. By the above, a plurality of the flux barriers 30 can be arranged while avoiding a portion where the through hole 20a is arranged.

When viewed in the axial direction, a central portion 30a in the extending direction of each of the first barrier portion 31 to the fifth barrier portion 35 has a shape including an arc projecting outward in the radial direction. Among arcs included in the central portions 30a of the flux barriers 30, the flux barrier 30 arranged on the inner side in the radial direction has a smaller arc radius, and the flux barrier 30 arranged on the outer side in the radial direction has a larger arc radius. Note that one or two or more of the flux barriers 30 located on the outer side in the radial direction when viewed in the axial direction may extend linearly in a direction orthogonal to the q axis without including an arc in the central portion 30a.

An end portion 30b on both sides in the extending direction of each of the flux barriers 30 is located in an outer peripheral edge portion in the radial direction of the rotor core 20. Positions in the radial direction of both of the end portions 30b of the flux barrier 30 are equivalent.

When viewed in the axial direction, at the central portion 30a in the extending direction of the flux barrier 30, width of the flux barrier 30 is smaller than width of the flux barrier 30 at the end portion 30b. Furthermore, at the central portions 30a of a plurality of the flux barriers 30, width of the flux barrier 30 on the inner side in the radial direction is narrower. Note that width of the flux barrier 30 is a dimension in a direction orthogonal to the extending direction of each of the flux barriers 30 as viewed in the axial direction.

By providing a region where width of the flux barrier 30 is narrow as described above, a plurality of the flux barriers 30 can be arranged while width of the magnetic path MP is suitably secured.

Note that widths of the first barrier portion 31 to the fifth barrier portion 35 may be, for example, uniform.

Note that, in the present description, “certain parameters are the same” includes not only a case where certain parameters are strictly the same as each other but also a case where certain parameters are substantially the same as each other. That “certain parameters are substantially the same as each other” includes, for example, a case where certain parameters slightly deviate from each other within a tolerance range.

### Projecting Portion 50

The rotor core 20 has the projecting portion 50 projecting from the edge portion 30e of the flux barrier 30 to the inside of the flux barrier 30.

The edge portion 30e includes a first edge portion 30e1 on the outer side in the radial direction of the flux barrier 30 and a second edge portion 30e2 on the inner side in the radial direction. In the present embodiment, the projecting portion 50 is provided at the first edge portion 30e1 on the outer side in the radial direction of the flux barrier 30. By the above, the magnetic flux F flowing from the outer side in the radial direction easily passes through the projecting portion 50.

In each of a plurality of the flux barrier groups 130, the edge portion 30e of at least one of the flux barriers 30 is provided with two or more of the projecting portions 50. In the present embodiment, a pair of the projecting portions 50 is arranged in each of the second barrier portion 32, the third barrier portion 33, the fourth barrier portion 34, and the fifth barrier portion 35.

The projecting portion 50 is not provided in the first barrier portion 31 arranged on the outermost side in the radial direction. This is because, in the first barrier portion 31 arranged at a position closest to the stator 3, an effect of controlling the magnetic flux F by the projecting portion 50 is weaker than that of the projecting portion 50 of another one of the flux barriers 30, and there is a case where flow of the magnetic flux F generated by the stator 3 can be controlled without providing the projecting portion 50.

Note that the projecting portion 50 may be provided in the first barrier portion 31.

Two of the projecting portions 50 included in one of the flux barriers 30 are arranged at intervals in the circumferential direction.

A pair of the projecting portions 50 arranged in each of the second barrier portion 32, the third barrier portion 33, the fourth barrier portion 34, and the fifth barrier portion 35 are arranged with an imaginary line IL extending in the radial direction through the center in the circumferential direction of the flux barrier 30 interposed between them when viewed in the axial direction. By the above, even in a case where the magnetic flux F generated by a rotating magnetic field passes through any position on the +θ side or the −θ side with respect to the imaginary line IL at the time of startup of the rotor 10, the magnetic flux F can be suitably caused to flow in a direction penetrating a width direction of the flux barrier 30 by one of a pair of the projecting portions 50. Note that the imaginary line IL may be arranged at a position overlapping the q axis.

A pair of the projecting portions 50 included in one of the flux barriers 30 are arranged in a manner line-symmetric to each other with respect to the imaginary line IL when viewed in the axial direction. By the above, even in a case where rotation of the rotor 10 is started in either the +θ direction or the −θ direction, torque of equivalent magnitude can be obtained. Further, even in a case where rotation of the rotor 10 is started in either the +θ direction or the −θ direction, an allowable inertial load at the time of startup can be improved.

In a pair of the projecting portions 50 provided on the edge portion 30e of the flux barrier 30 located further on the outer side in the radial direction, an interval in the circumferential direction between a pair of the projecting portions 50 is smaller. That is, an interval between a pair of the projecting portions 50 of the second barrier portion 32 is smaller than an interval between a pair of the projecting portions 50 of the third barrier portion 33. An interval between a pair of the projecting portions 50 of the third barrier portion 33 is smaller than an interval between a pair of the projecting portions 50 of the fourth barrier portion 34. An interval between a pair of the projecting portions 50 of the fourth barrier portion 34 is smaller than an interval between a pair of the projecting portions 50 of the fifth barrier portion 35.

By the above, a plurality of the projecting portions 50 can be suitably arranged, and the magnetic flux F can be easily caused to flow along a plurality of the projecting portions 50. Further, the magnetic flux F can be caused to pass through a plurality of the flux barrier groups 130 while avoiding the through hole 20a.

Note that a distance between a pair of the projecting portions 50 included in one of the flux barriers 30 is preferably 5 mm or more. By the above, when the conductor 40 is arranged in the flux barrier 30, the melted conductor 40 can be appropriately caused to flow into between two of the projecting portions 50.

When viewed in the axial direction, dimensions of the projecting portions 50 in a direction orthogonal to a direction in which the projecting portion 50 projects are uniform. That is, the projecting portion 50 has a rectangular shape. Hereinafter, a dimension of the projecting portion 50 in a direction orthogonal to a direction in which the projecting portion 50 projects is also referred to as width of the projecting portion 50. Width of the projecting portion 50 is preferably set to a dimension capable of guiding flow of the magnetic flux F.

A tip of the projecting portion 50 is not in contact with the second edge portion 30e2. Further, the conductor 40 in one of the flux barriers 30 is not electrically divided by the projecting portion 50. Furthermore, when viewed in the axial direction, a distance between a tip of the projecting portion 50 and the second edge portion 30e2 facing the first edge portion 30e1 where the projecting portion 50 is arranged is preferably 1.5 mm or more. By the above, when the conductor 40 is arranged in the flux barrier 30, the melted conductor 40 can be appropriately caused to flow into the flux barrier 30.

As described above, the rotor of the present embodiment is the rotor 10 rotatable about a central axis. The rotor 10 includes the rotor core 20, and a plurality of the flux barrier groups 130 provided in the rotor core 20 and arranged at intervals in the circumferential direction. Each of a plurality of the flux barrier groups 130 includes a plurality of the flux barriers 30 arranged side by side at intervals in the radial direction, the rotor core 20 has the projecting portion 50 projecting from the edge portion 30e of the flux barrier 30 toward the inside of the flux barrier 30, and in each of a plurality of the flux barrier groups 130, the edge portion 30e of at least one of the flux barriers 30 is provided with two or more of the projecting portions 50.

In the rotor 10 of the present embodiment, when rotation of the rotor 10 in a stationary state is started, the projecting portion 50 enables the magnetic flux F generated from the stator 3 to suitably flow to the rotor 10 as illustrated in FIG. 3. As described above, the rotor 10 of the present embodiment has a structure capable of improving an allowable inertial load at the time of startup of the rotary electric machine 1. Since a magnetic field generated by the stator 3 can be suitably used, it is possible to prevent an inertial load of the rotor 10 at the time of startup of the rotary electric machine 1 from exceeding a maximum inertial load of the rotary electric machine 1 that can be allowed in a case where the rotor 10 is rotated to a rated speed, and it is possible to increase a rotational speed of the rotor 10 to the rated speed in an excellent manner.

Furthermore, in a steady state where a rotation speed of the rotor 10 is a rated speed, the rotor 10 can be suitably rotated by reluctance torque generated by arrangement of the flux barrier group 130.

Further, the rotary electric machine 1 of the present embodiment includes the above-described rotor 10 and the stator 3 located outside in the radial direction of the rotor 10.

As described above, since the rotary electric machine 1 includes the rotor 10 capable of suitably allowing the magnetic flux F of a rotating magnetic field to pass through, an allowable inertial load at the time of startup of the rotary electric machine 1 can be improved.

The present disclosure is not limited to the above-described embodiment, and other configurations may be employed within the scope of the technical idea of the present disclosure.

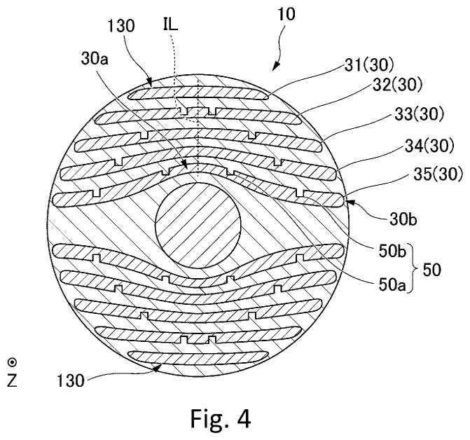

For example, as illustrated in FIG. 4, the number of a plurality of the projecting portions 50 arranged in one of the flux barriers 30 may be two or more. In the example illustrated in FIG. 4, the projecting portion 50 is not arranged in the first barrier portion 31, two of the projecting portions 50 are arranged in each of the second to fourth barrier portions 32 to 34, and four of the projecting portions 50 are arranged in the fifth barrier portion 35. The projecting portion 50 of the fifth barrier portion 35 in FIG. 4 includes a first projecting portion 50a and a second projecting portion 50b arranged further on the end portion 30b side than the first projecting portion 50a in an extending direction of the fifth barrier portion 35. In the example illustrated in FIG. 4, a plurality of the projecting portions 50 of the second to fifth barrier portions 32 to 35 are arranged at positions line-symmetric to each other with respect to the imaginary line IL.

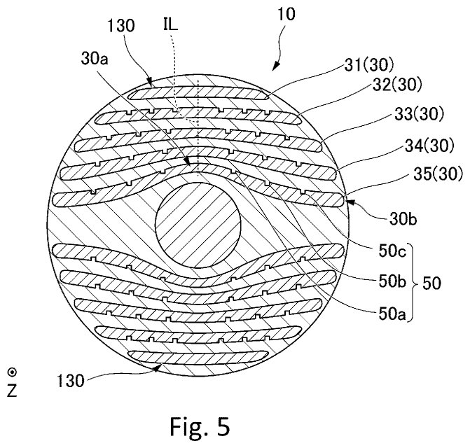

Further, four or six of the projecting portions 50 may be arranged in each of the flux barriers 30. In the rotor 10 illustrated in FIG. 5, six of the projecting portions 50 are arranged in each of the second to fifth barrier portions 32 to 35. In the example illustrated in FIG. 5, each of the projecting portions 50 of the second to fifth barrier portions 32 to 35 includes the first projecting portion 50a, the second projecting portion 50b, and a third projecting portion 50c. In the second to fifth barrier portions 32 to 35 illustrated in FIG. 5, the first projecting portion 50a, the second projecting portion 50b, and the third projecting portion 50c are arranged in this order from the central portion 30a toward the end portion 30b in an extending direction. In the example illustrated in FIG. 5, a plurality of the projecting portions 50 of the second to fifth barrier portions 32 to 35 are arranged at positions line-symmetric to each other with respect to the imaginary line IL.

Note that the number of the projecting portions 50 may be appropriately changed in consideration of size of the rotor 10 and a shape of the flux barrier 30. For example, since the projecting portion 50 is not arranged on the q axis and a plurality of the projecting portions 50 are arranged in q-axis symmetry, the number of the projecting portions 50 arranged in one of the flux barriers 30 may be an even number of two or more.

However, the number of the projecting portions 50 arranged in each of the flux barriers 30 is preferably two or more and four or less. This is because if the number of the projecting portions 50 is excessively large, flow of the magnetic flux F may be affected when rotation of the rotor 10 becomes in a steady state.

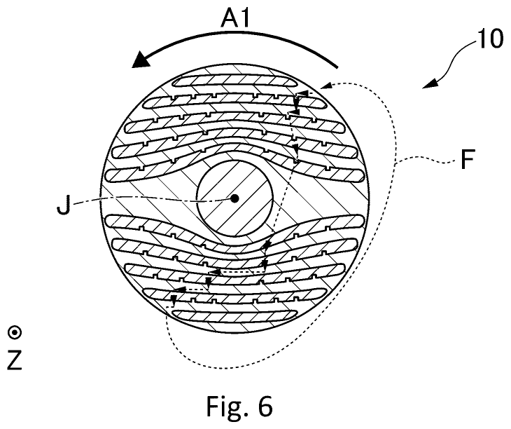

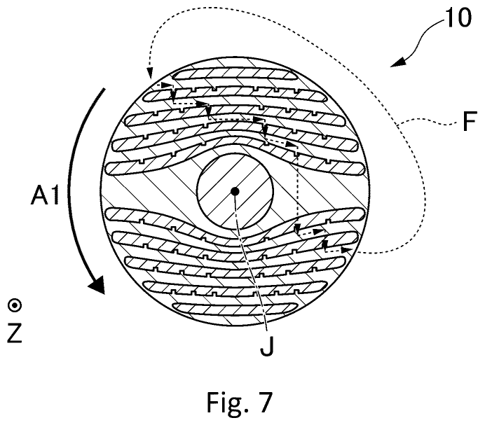

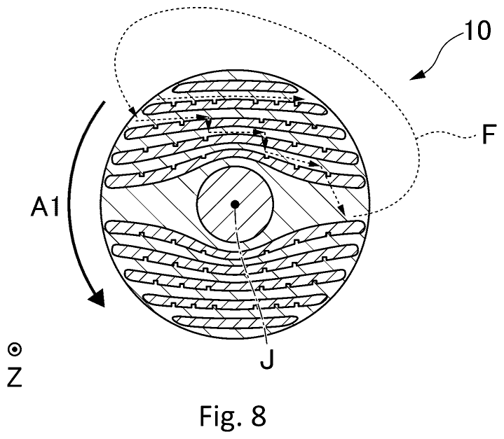

FIGS. 6 to 8 illustrate flow of the magnetic flux F in the rotor 10 illustrated in FIG. 5 when a magnetic field generated by the stator 3 starts to rotate in a direction of an arrow A1. By arranging a plurality of the projecting portions 50, as illustrated in FIGS. 6 to 8, the magnetic flux F can be caused to pass through the rotor 10 by a plurality of the projecting portions 50 even in a state where a rotating magnetic field is arranged at any angle with respect to the central axis J. By the above, it is possible to suitably obtain torque due to the Lorentz force when the rotor 10 in a stationary state starts rotation.

Further, an interval between a pair of the projecting portions 50 in a case where only a pair of the projecting portions 50 are provided in one of the flux barriers 30 is not limited to that in the example illustrated in FIG. 2. For example, the flux barrier 30 may be provided with only a pair of the projecting portions 50 arranged at a position of the first projecting portion 50a illustrated in FIG. 5, may be provided with only a pair of the projecting portions 50 arranged at a position of the second projecting portion 50b, or may be provided with only a pair of the projecting portions 50 arranged at a position of the third projecting portion 50c.

Further, the number of the magnetic pole portions P of the rotor 10 is not limited to two poles, and may be more than two poles. The number of the magnetic pole portions P of the rotor 10 may be, for example, four poles, six poles, or eight poles.

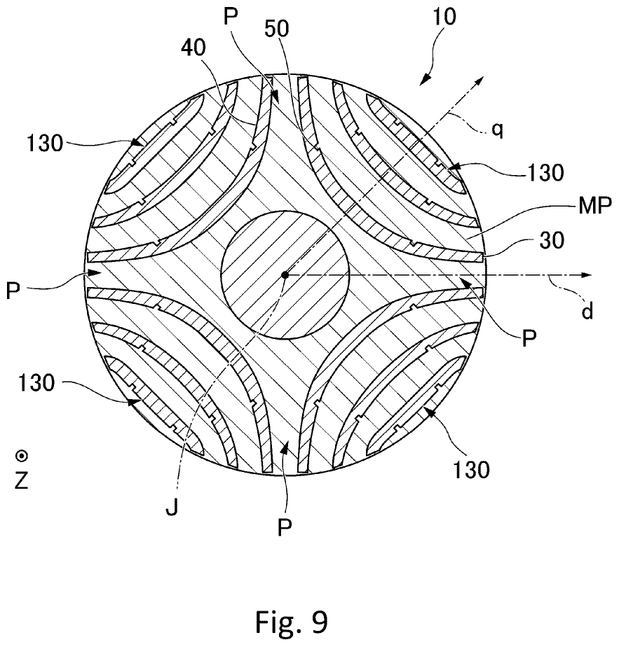

FIG. 9 illustrates the rotor 10 having a four-pole structure. Four sets of the flux barrier groups 130 are arranged at equal intervals along the circumferential direction of the rotor 10. Since the magnetic pole portion P is provided between the flux barrier groups 130 adjacent to each other in the circumferential direction, four poles of the magnetic pole portions P are provided in the rotor 10 illustrated in FIG. 9.

Note that, in the rotor 10 illustrated in FIG. 9, a shape of a plurality of the flux barriers 30 is an arc shape projecting inward in the radial direction as viewed in the axial direction. As described above, a shape of the flux barrier 30 may be an arc shape that projects inward in the radial direction when viewed in the axial direction, or may be a polygonal line shape that projects inward in the radial direction when viewed in the axial direction. Further, one set of the flux barrier groups 130 may include both the flux barrier 30 having an arc shape and the flux barrier 30 having a polygonal line shape.

Further, the projecting portion 50 may include the projecting portion 50 provided in the second edge portion 30e2 on the inner side in the radial direction of the flux barrier 30. By the above, the magnetic flux F flowing from the inner side in the radial direction through another one of the flux barrier groups 130 can be easily caused to pass through the projecting portion 50.

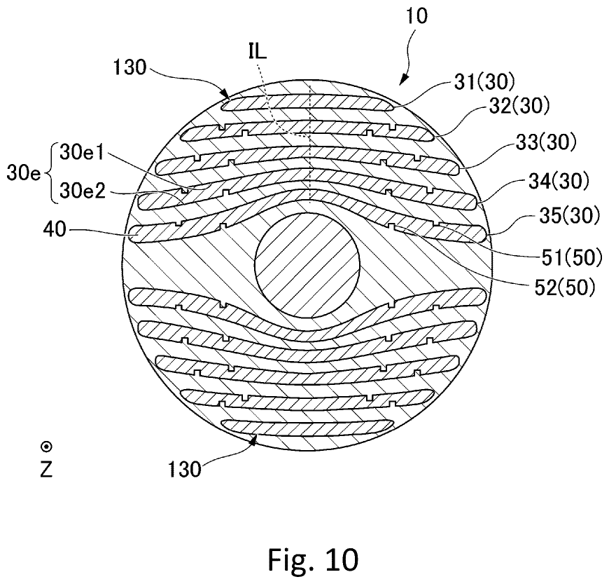

For example, as illustrated in FIG. 10, an outer projecting portion 51 provided on the first edge portion 30e1 on the outer side in the radial direction and an inner projecting portion 52 provided on the second edge portion 30e2 on the inner side in the radial direction may be provided in the flux barrier 30. The outer projecting portion 51 and the inner projecting portion 52 are arranged at different positions in an extending direction of the flux barrier 30. By the above, both the magnetic flux F flowing from the outer side in the radial direction and the magnetic flux F flowing from the inner side in the radial direction can be more suitably guided by the projecting portion 50.

Further, the outer projecting portion 51 and the inner projecting portion 52 may be arranged at the same position in an extending direction of the flux barrier 30. That is, in the flux barrier 30, the outer projecting portion 51 and the inner projecting portion 52 may be arranged at positions facing each other in a direction orthogonal to both the axial direction and the extending direction. Also in this case, both the magnetic flux F flowing from the outer side in the radial direction and the magnetic flux F flowing from the inner side in the radial direction can be more suitably guided by the projecting portion 50. Here, for example, in a case where a dimension of the projecting portion 50 in a direction in which the projecting portion 50 projects is designed to be long, there is a case where the projecting portion 50 is easily deformed at the time of manufacturing. In such a case, by dividing one of the projecting portions 50 into two portions, the outer projecting portion 51 and the inner projecting portion 52, it is possible to prevent deformation of the projecting portion 50 in a manufacturing process while securing a total projecting dimension of the projecting portion 50 and obtaining an effect of guiding the magnetic flux F.

Note that, as described above, a distance between a tip of the outer projecting portion 51 and a tip of the inner projecting portion 52 is preferably 1.5 mm or more so that the conductor 40 can be poured.

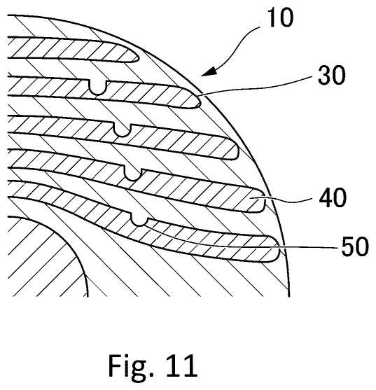

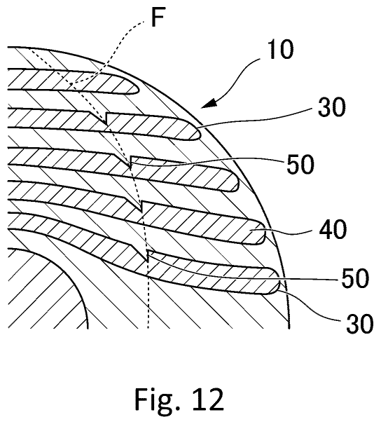

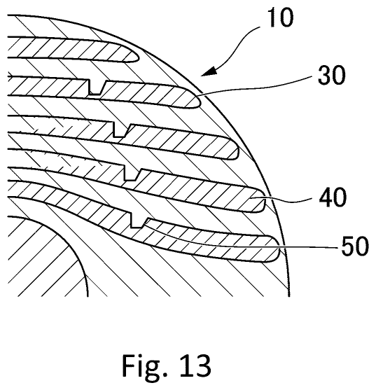

Further, a shape of the projecting portion 50 is not limited to a rectangle. That is, when viewed in the axial direction, dimensions of the projecting portions 50 in a direction orthogonal to a direction in which the projecting portion 50 projects do not need to be uniform. For example, the projecting portion 50 may have a semi-elliptical shape as viewed in the axial direction as illustrated in FIG. 11, the projecting portion 50 may have a triangular shape as viewed in the axial direction as illustrated in FIG. 12, and the projecting portion 50 may have a trapezoidal shape as viewed in the axial direction as illustrated in FIG. 13.

More specifically, in the rotor 10 illustrated in FIGS. 11 to 13, when viewed in the axial direction, dimensions of the projecting portions 50 in a direction orthogonal to a direction in which the projecting portion 50 projects are smaller as the projecting portions 50 are more away from the edge portion 30e of the flux barrier 30. By the above, it is easy to suitably guide the magnetic flux F flowing in the projecting portion 50 along the projecting portion 50. Further, in the rotor 10 illustrated in FIG. 12, the projecting portion 50 of the flux barriers 30 arranged on the inner side in the radial direction is arranged in a direction pointed by a triangular tip of the projecting portion 50 arranged in another one of the flux barrier 30 on the outer side in the radial direction. By the above, the magnetic flux F flowing through one of the projecting portions 50 can be easily guided to another one of the projecting portions 50. Therefore, the magnetic flux F can be more suitably guided along a plurality of the projecting portions 50.

Note that a shape of the projecting portion 50 may be appropriately changed in consideration of an inertial load both at the time of startup and at the time of steady rotation. Further, in order to suitably guide the magnetic flux F flowing to the projecting portion 50 at the time of startup in a direction penetrating the flux barrier 30 in a width direction, dimensions of the projecting portions 50 in a direction orthogonal to a direction in which the projecting portion 50 projects when viewed in the axial direction preferably do not become larger as the projecting portions 50 are more away from the edge portion 30e of the flux barrier 30.

Further, a plurality of the projecting portions 50 do not need to be arranged at symmetrical positions with respect to the imaginary line IL or the q axis. Further, one of the flux barriers 30 may have an odd number of the projecting portions 50. As described above, by asymmetrically arranging the projecting portions 50, it is possible to particularly improve an inertial load when the rotor 10 starts rotation in any one of directions to the +θ side and the −θ side.

Further, the flux barrier 30 does not need to penetrate the rotor core 20 in the axial direction. The flux barrier 30 may be open to an end surface in the axial direction of the rotor core 20.

The flux barrier 30 is not particularly limited as long as flow of the magnetic flux F can be controlled. In the above-described embodiment, the conductor 40 is configured to be arranged in the flux barrier 30, but the inside of the flux barrier 30 may be a void portion. Further, the flux barrier 30 may be configured by embedding a non-magnetic material such as resin in the void portion. Even if the conductor 40 is not arranged in the flux barrier 30, flow of the magnetic flux F can be suitably guided by the projecting portion 50.

Application of a rotary electric machine to which the present disclosure is applied is not particularly limited. For example, the rotary electric machine may be mounted on a vehicle or may be mounted on equipment other than a vehicle. The configurations described above in the present description may be appropriately combined in a range where no conflict arises.

1-8. (canceled)

9. A rotor rotatable about a central axis, the rotor comprising:
a rotor core; and
a plurality of flux barrier groups provided in the rotor core and arranged at intervals in a circumferential direction,
wherein each of the plurality of flux barrier groups includes a plurality of flux barriers arranged side by side at intervals in a radial direction,
the rotor core has a projecting portion projecting from an edge portion of the flux barrier toward an inside of the flux barrier, and
in each of the plurality of flux barrier groups, an edge portion of at least one of the flux barriers is provided with two or more of the projecting portions.

10. The rotor according to claim 9, wherein
the two or more of projecting portions include a pair of the projecting portions arranged at intervals in the circumferential direction, and
the pair of projecting portions are arranged with an imaginary line extending in the radial direction through a center in the circumferential direction of the flux barrier interposed therebetween as viewed in an axial direction.

11. The rotor according to claim 10, wherein the pair of projecting portions are arranged in a manner line-symmetric to each other with respect to the imaginary line when viewed in the axial direction.

12. The rotor according to claim 10, wherein
in each of the plurality of flux barrier groups, the pair of projecting portions are provided at an edge portion of two or more of the flux barriers, and
the pair of projecting portions provided at an edge portion of the flux barrier located further on an outer side in the radial direction has a smaller interval in the circumferential direction between the pair of projecting portions.

13. The rotor according to claim 11, wherein
in each of the plurality of flux barrier groups, the pair of projecting portions are provided at an edge portion of two or more of the flux barriers, and
the pair of projecting portions provided at an edge portion of the flux barrier located further on an outer side in the radial direction has a smaller interval in the circumferential direction between the pair of projecting portions.

14. The rotor according to claim 9, wherein the projecting portion includes a projecting portion provided on a first edge portion on an outer side in the radial direction of the flux barrier.

15. The rotor according to claim 13, wherein the projecting portion includes a projecting portion provided on a first edge portion on an outer side in the radial direction of the flux barrier.

16. The rotor according to claim 9, wherein the projecting portion includes a projecting portion provided on a second edge portion on an inner side in the radial direction of the flux barrier.

17. The rotor according to claim 15, wherein the projecting portion includes a projecting portion provided on a second edge portion on an inner side in the radial direction of the flux barrier.

18. The rotor according to claim 9, wherein when viewed in the axial direction, dimensions of the projecting portions in a direction orthogonal to a direction in which the projecting portion projects are uniform or smaller as the projecting portions are more away from an edge portion of the flux barrier.

19. The rotor according to claim 17, wherein when viewed in the axial direction, dimensions of the projecting portions in a direction orthogonal to a direction in which the projecting portion projects are uniform or smaller as the projecting portions are more away from an edge portion of the flux barrier.

20. A rotary electric machine comprising:
the rotor according to claims 9; and
a stator located outside in a radial direction of the rotor.

21. A rotary electric machine comprising:
the rotor according to claims 19; and
a stator located outside in a radial direction of the rotor.
